(19) United States
(12) Patent Application Publication
(10) Pub. No.: US 2004/0168308 A1
(43) Pub. Date: Sep. 2, 2004

(54) Unit for crimping electric terminals to respective conducting tracks on a flat cable

(76) Inventor: Luigi Aluffo, Fubine (IT)

Correspondence Address: HARRINGTON & SMITH, LLP, 4 RESEARCH DRIVE, SHELTON, CT, 06484-6212, US

(21) Appl. No.: 10/474,491

(22) PCT Filed: Apr. 12, 2002
(86) PCT No.: PCT/EP02/04106

(30) Foreign Application Priority Data
Apr. 13, 2001 (IT) TO2001A 000368

(51) Int. Cl. B23P 19/00

(52) U.S. Cl. 29/761; 29/753

(57) ABSTRACT

There is described a unit (1) for crimping electric terminals (2) of a connector (3) to respective conducting tracks (4) of a flat cable (5). The unit (1) has an anvil assembly (26) having receiving means (36) for receiving a connector (3); a pressure assembly (27) movable to and from the anvil assembly (26) in an approach direction (B), and having matrix means (104, 105) which are pressed onto the receiving means (36) to crimp the terminals (2) to respective conducting tracks (4) on a crimping portion (8) of the flat cable (5); and adjustable fastening means (37) for fixing the receiving means (36) and the matrix means (104, 105) to first and second supporting means (35, 96) respectively in a number of lock positions in an adjustment direction (D) crosswise to the flat cable (5) and to the approach direction (B), so as to align the conducting tracks (4) of the flat cable (5) with the terminals (2) of the connector (3) regardless of the number of conducting tracks (4) and terminals (2), and regardless of the position in which the crimping portion (8) of the flat cable (5) is fed to the unit (1).

### TECHNICAL FIELD

The present invention relates to a unit for crimping electric terminals to respective conducting tracks on a flat cable.

### BACKGROUND ART

As is known, flat cables substantially comprise a strip of insulating material, to which are applied longitudinally a number of parallel conducting tracks, possibly covered with a further layer of protective insulating material.

Flat cables of the type described above are normally supplied with a standard number of conducting tracks—normally twelve—and, depending on the end use and electric connections involved, can be cut longitudinally at the ends to obtain crimping portions separated laterally and each having the required number of conducting tracks.

Electric terminals are normally housed through respective cavities in an insulating casing of an electric connector, and are pressed onto the flat cable and crimped simultaneously to respective conducting tracks on the crimping portion of the cable.

More specifically, each terminal comprises a connecting portion projecting outwards from the connector casing, and which is crimped to a respective conducting track on the flat cable; and a contact portion connectable to a complementary terminal.

As is known, for example, from U.S. Pat. No. 4,749,368, the connecting portion of each terminal is in the form of a flat blade from which project perpendicularly two groups of triangular spikes arranged in a circle. The spikes in each group are formed by cross-cutting the connecting portion and then folding the resulting tabs in the same direction perpendicular to the connecting portion, and are pressed onto the crimping portion of the flat cable, at a respective conducting track, to pierce the crimping portion locally, and are then folded onto the conducting track.

For crimping to be performed correctly, the conducting tracks on the crimping portion of the flat cable must therefore be aligned perfectly with the connecting portions of the terminals.

And this must obviously be possible regardless of the number and mutual arrangement of the conducting tracks and electric terminals for crimping.

### DISCLOSURE OF INVENTION

It is an object of the present invention to provide a unit for crimping electric terminals to respective conducting tracks on a flat cable, and which provides, in a straightforward, low-cost, reliable manner, for crimping connectors with any number of electric terminals to crimping portions of flat cables having a corresponding number of conducting tracks and fed to the unit in different positions in a direction crosswise to the tracks.

According to the present invention, there is provided a unit for crimping electric terminals to respective conducting tracks on a flat cable, as claimed in claim 1.

### BRIEF DESCRIPTION OF THE DRAWINGS

A preferred, non-limiting embodiment of the present invention will be described by way of example with reference to the accompanying drawings, in which:

FIG. 1 shows a view in perspective of a unit in accordance with the present invention for crimping the terminals of an electric connector to a flat cable;

FIG. 2 shows a front view of the FIG. 1 unit;

FIG. 3 shows a section along line III-III in FIG. 2;

FIG. 4 shows a larger-scale section along line IV-IV in FIG. 2;

FIG. 5 shows a larger-scale view in perspective of an electric connector, and a crimping portion of a flat cable to which the connector is crimped on the FIG. 1 unit;

FIG. 6 shows a larger-scale detail of the FIG. 5 connector;

FIG. 7 shows a larger-scale view in perspective of an anvil assembly of the FIG. 1 unit for receiving the connector to be crimped to the flat cable;

FIG. 8 shows a smaller-scale vertical section of the FIG. 7 anvil assembly;

FIG. 9 shows a section along line IX-IX in FIG. 8;

FIGS. 10 and 11 show views in perspective of two details of the FIG. 7 anvil assembly;

FIG. 12 shows a vertical section of an anvil of the FIG. 7 and 8 anvil assembly;

FIG. 13 shows a section along line XIII-XIII in FIG. 12;

FIG. 14 shows a top plan view of the FIG. 12 anvil;

FIGS. 15 and 16 show views in perspective of two component parts of the FIG. 12 and 14 anvil;

FIG. 17 shows a smaller-scale vertical section of a pressure assembly of the FIG. 1 unit, which is pressed onto the FIG. 7 anvil assembly;

FIG. 18 shows a section along line XVIII-XVIII in FIG. 17;

FIG. 19 shows a much larger-scale detail of a crimping matrix of the FIG. 17 pressure assembly;

FIG. 20 shows a section along line XX-XX in FIG. 19.

### BEST MODE FOR CARRYING OUT THE INVENTION

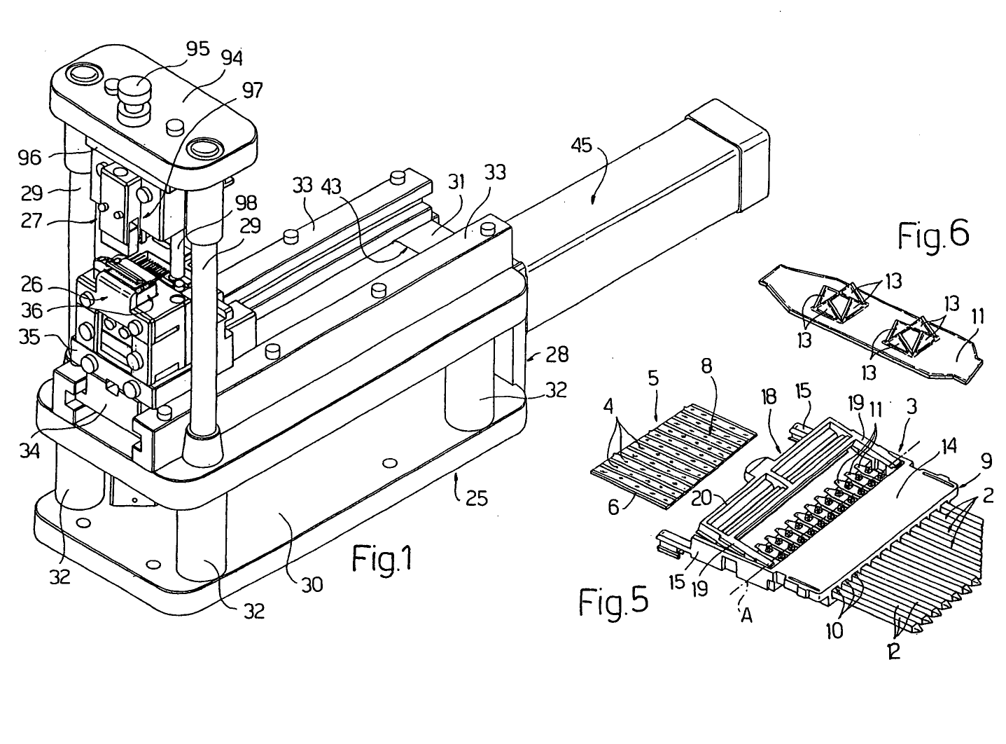

With reference to FIGS. 1, 2 and 4, number 1 indicates as a whole a unit for crimping electric terminals 2 of an electric connector 3 to respective conducting tracks 4 of a flat cable 5.

As is known (FIG. 5), flat cable 5 is defined by a rectangular strip 6 of insulating material, to which parallel conducting tracks 4 are applied longitudinally. Flat cable 5 may also comprise a further layer of insulating material (not shown) covering conducting tracks 4 on the opposite side to strip 6.

Flat cables of the type shown in FIG. 5 are normally supplied with a standard number of conducting tracks 4—normally twelve—and, depending on the end use and electric connections involved, can be cut longitudinally at the ends to obtain cable portions separated laterally and each having the required number of conducting tracks 4.

For simplicity, the end portion of flat cable 5 for connection to relative connector 3 will be referred to hereinafter as “crimping portion” 8. Crimping portion 8 may therefore be defined by the whole end portion of a standard flat cable 5, i.e. having a standard number of conducting tracks 4 and not cut longitudinally beforehand, or may be defined by a longitudinal end portion of a standard flat cable 5 separated laterally from the rest of cable 5.

As shown in FIG. 5, connector 3 comprises a flat insulating casing 9 defining a row of parallel through cavities 10 for housing respective terminals 2.

More specifically, each terminal 2 (FIGS. 5 and 6) comprises a connecting portion 11 which is crimped to a relative conducting track 4 on crimping portion 8 of flat cable 5; and a male contact portion 12 connectable to a complementary terminal (not shown).

Connecting portion 11 of each terminal 2 is in the form of a flat blade, from which two longitudinally spaced groups of four spikes 13 project perpendicularly. The spikes 13 in each group are arranged to define a square, and are formed by cross-cutting connecting portion 11 and then bending the resulting tabs in the same direction perpendicular to connecting portion 11. Spikes 13 (FIG. 6) are substantially triangular with curved, slightly convex opposite sides, and, as explained in detail later on, are pressed onto crimping portion 8 of flat cable 5, at a respective conducting track 4, to pierce crimping portion 8 locally, and are then pressed onto conducting track 4.

Casing 9 of connector 3 comprises a box-shaped, substantially flat parallelepiped-shaped main portion 14 defining cavities 10; and two lateral arms 15 projecting perpendicularly from an end surface of main portion 14, extending parallel to the axes of cavities 10 along extensions of respective opposite lateral edges of main portion 14, and connected to each other, at a distance from said end surface, by a crosspiece 17.

Terminals 2 are housed through respective cavities 10 of main portion 14 of casing 9, with connecting portions 11 projecting on the side facing arms 15, and with contact portions 12 projecting on the opposite side.

Connector 3 also comprises a substantially C-shaped cover 18 hinged to arms 15 of casing 9 about an axis A perpendicular to arms 15.

More specifically, cover 18 comprises two parallel elongated lateral portions 19 hinged at the free ends to respective arms 15, close to main portion 14 of casing 9; and a front portion 20 extending perpendicularly between respective opposite ends of lateral portions 19 and facing crosspiece 17 of casing 9.

Cover 18 is fitted between arms 15, and, together with main portion 14 of casing 9, defines a through opening through which to crimp connecting portions 11 of terminals 2 onto flat cable 5, as explained in detail later on.

Cover 18 rotates about axis A between a raised open position, in which it slopes with respect to the plane of casing 9, and therefore with respect to arms 15, to permit insertion of crimping portion 8 of flat cable 5 between arms 15 and between front portion 20 and spikes 13 of connecting portions 11 of terminals 2; and a lowered closed position, in which it is coplanar with casing 9, clicks onto arms 15, and exerts pressure on crimping portion 8 of flat cable 5 on the opposite side to connecting portions 11 of terminals 2.

Cover 18 clicks onto casing 9 by means of two projections projecting laterally from respective lateral portions 19 at front portion 20, and which cooperate with retaining means (not shown) on respective arms 15.

With reference to FIGS. 1 to 4, unit 1 substantially comprises a supporting frame 25; a bottom anvil assembly 26 defining a support for connector 3; and a top pressure assembly 27, which is movable to and from anvil assembly 26 in a vertical approach direction B, and is pressed onto anvil assembly 26 to crimp terminals 2 onto respective conducting tracks 4 of crimping portion 8 of flat cable 5, and to click cover 18 onto casing 9 of connector 3.

Flat cable 5 is fed to unit 1 in a horizontal direction C coincident with the direction of extension of cable 5, and in a predetermined fixed horizontal position with respect to unit 1. More specifically, crimping portion 8 of flat cable 5 is fed into connector 3 as described above between anvil assembly 26 and pressure assembly 27.

Depending on whether or not the end of flat cable 5 is cut longitudinally, the number of conducting tracks 4 defining crimping portion 8, and the position, in a direction D perpendicular to directions B and C, in which crimping portion 8 is fed to unit 1 may vary.

Frame 25 comprises a horizontal base structure 28 elongated in direction C, and to which anvil assembly 26 is fitted to slide in direction C; and two cylindrical columns 29 projecting vertically from a front end portion of base structure 28, and on which pressure assembly 27 slides.

More specifically, base structure 28 is defined by two plates 30, 31 of identical substantially rectangular shape, one (30) of which defines a horizontal supporting base of unit 1, while the other (31) is maintained parallel to plate 30 by four cylindrical supporting legs 32 extending perpendicularly between respective corner portions of plates 30, 31.

Columns 29 project perpendicularly from an end portion of plate 31, substantially along extensions of respective legs 32.

The top surface of plate 31 is fitted, by means of screws, with two C-section rails 33 positioned with their concavities facing, and extending parallel to direction C along the whole length of plate 31.

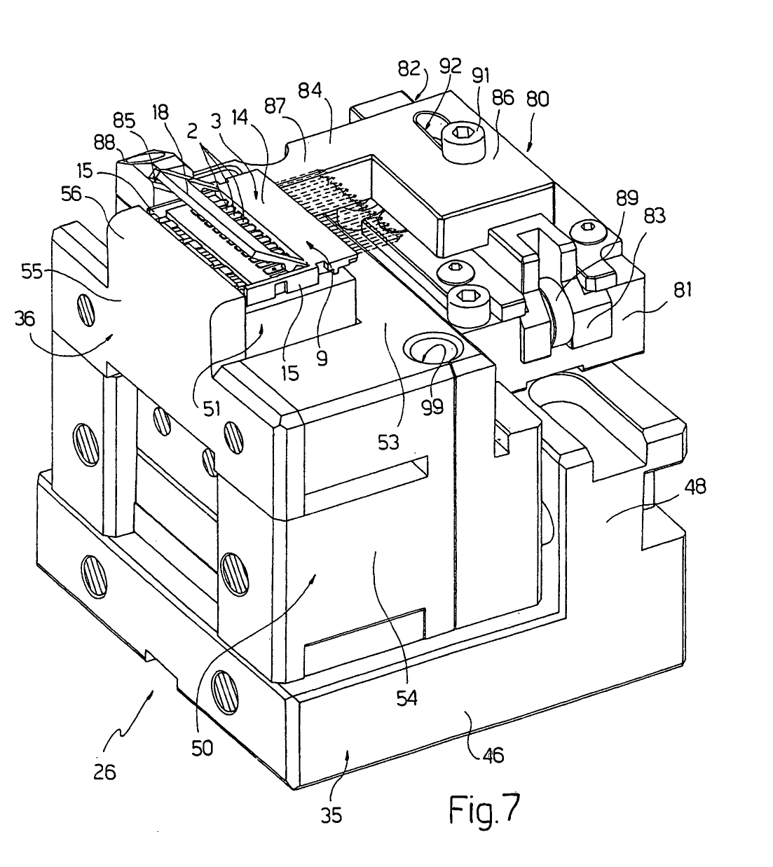

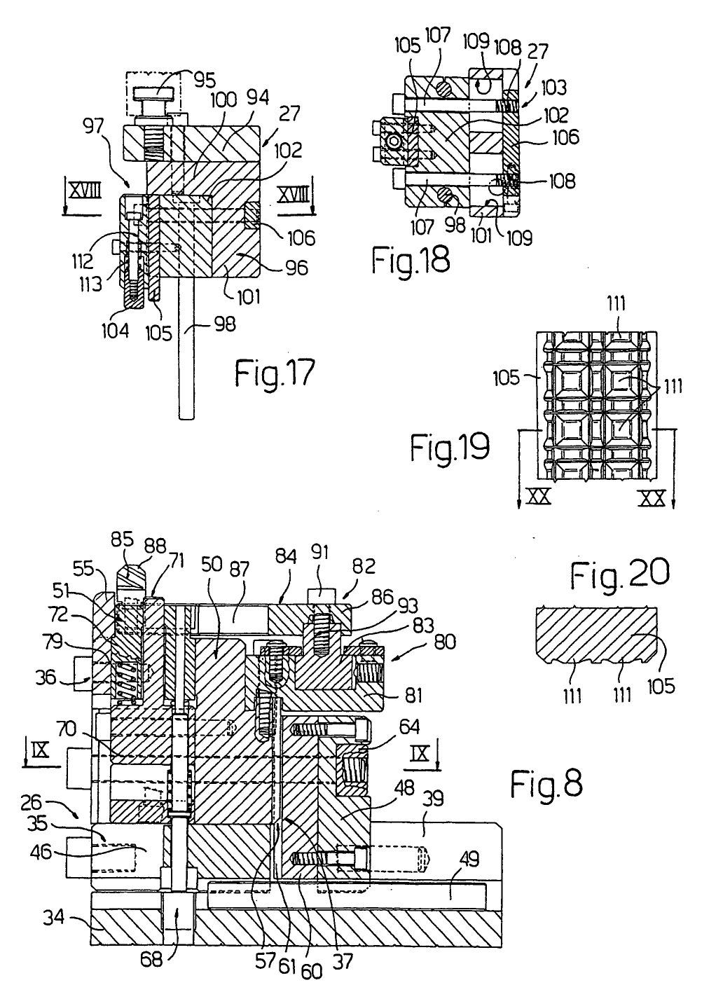

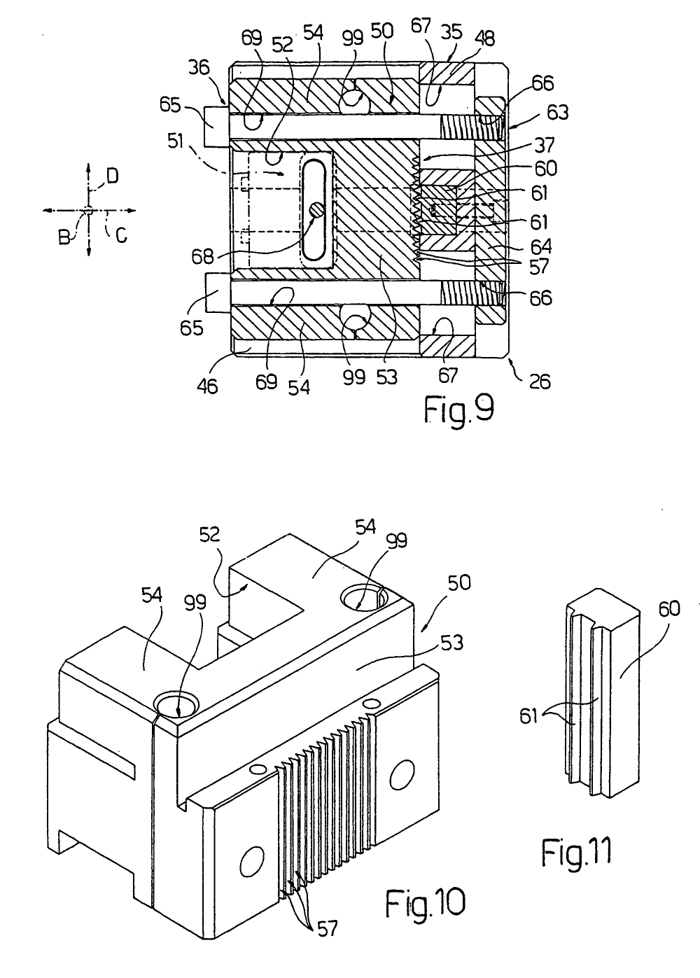

With reference to FIGS. 1-4 and 7-9, anvil assembly 26 comprises a slide 34 mounted to run along rails 33; a laterally L-shaped supporting member 35 fitted on top of slide 34; a receiving assembly 36 fitted to supporting member 35 and for receiving connector 3; and adjustable locking means 37 for fixing receiving assembly 36 to supporting member 35 in a number of discrete lock positions in direction D, so as to align conducting tracks 4 on crimping portion 8 of flat cable 5 with terminals 2 of connector 3, regardless of the number of terminals 2 and the position in which crimping portion 8 is fed to unit 1.

As shown clearly in FIGS. 1-4 and 8, slide 34 is substantially in the form of a rectangular plate, and has two lateral longitudinal projections 38 which engage and run along respective rails 33.

At the rear, i.e. on the opposite side to that in which crimping portion 8 of flat cable 5 is fed to unit 1, slide 34 comprises two appendixes 39 projecting from slide 34 in direction B and spaced apart in direction D.

Finally, slide 34 is fitted underneath with a control arm 40 extending through a longitudinal through opening 43 in plate 31, and having a free end connected to an output member 44 of an actuator 45—in the example shown, a pneumatic cylinder—fitted to base structure 28 and interposed between plates 30 and 31. Slide 34 is moved by actuator 45 along rails 33 between a front operating position (FIGS. 1 to 4) in which anvil assembly 26 and pressure assembly 27 are positioned facing each other to perform the crimping operation, and a rear loading position in which anvil assembly 26 is positioned outside the work area of pressure assembly 27—more specifically, close to the rear end of plate 31 to—enable connector 3 to be loaded onto receiving assembly 36 by a manipulator (not shown, by not forming part of the present invention).

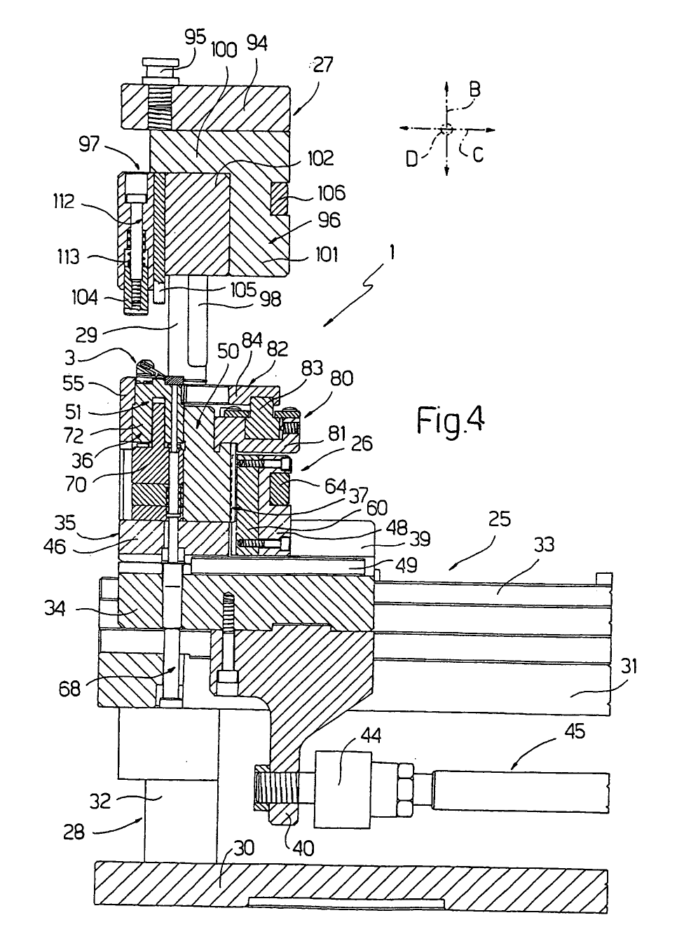

With particular reference to FIGS. 4, 7, 8 and 9, supporting member 35 comprises a base portion 46 in the form of a rectangular plate resting horizontally on a top surface of slide 34 and fixed against appendixes 39 of slide 34 by means of two screws; and a rear raised portion 48 projecting perpendicularly from the rear end of base portion 46. Supporting member 35 and slide 34 are centered in direction D by means of a key 49 engaging two facing seats formed in respective contact surfaces of slide 34 and base portion 46 of supporting member 35.

With particular reference to FIGS. 4, 7, 8, 9, 10 and 11, receiving assembly 36 comprises a fastening member 50 connectable to supporting member 35, by adjustable locking means 37, in a given lock position in direction D; and an anvil 51 fixed to fastening member 50 and defining a bottom support for connector 3 and relative terminals 2.

More specifically, fastening member 50 (FIG. 10) is C-shaped when viewed from above, is open on the side on which crimping portion 8 of flat cable 5 is fed to unit 1, and defines a vertical seat 52 for receiving anvil 51. Fastening member 50 rests on base portion 46 of supporting member 35, and comprises an end portion 53 in the form of a plate extending perpendicularly to direction C and resting against raised portion 48; and two wings 54 projecting perpendicularly from respective lateral end portions of end portion 53 and in the opposite direction to raised portion 48. A substantially inverted-T-shaped cover 55 is fixed by means of screws to the top portions of respective free end edges of wings 54, is positioned facing and parallel to end portion 53, and has a portion 56 projecting upwards with respect to fastening member 50 and defining a front contact surface for arms 15 of casing 9 of connector 3.

As shown in FIGS. 4, 8, 9, 10 and 11, adjustable locking means 37 comprise a number of vertical V-section grooves 57 formed in a peripheral surface of end portion 53 of fastening member 50 facing raised portion 48 of supporting member 35; and a retaining member 60, which has two vertical V-section projections 61 for engaging two of grooves 57, and is fixed by means of screws inside a vertical C-shaped seat formed in an intermediate position on raised portion 48 with its concavity facing end portion 53 of fastening member 50.

More specifically, grooves 57 are arranged side by side, and define respective discrete lock positions of fastening member 50 and supporting member 35 in direction D.

Retaining member 60 is defined by a rectangular-section bar with projections 61 on one face. More specifically, projections 61 are complementary in shape to that of grooves 57, and extend longitudinally and parallel to each other along the whole length of retaining member 60.

Adjustable locking means 37 also comprise releasable fastening means 63 for fastening fastening member 50 to raised portion 48 of supporting member 35 in direction C.

Fastening means 63 comprise a bar 64 fitted to raised portion 48 of supporting member 35, on the opposite side to retaining member 60, so as to slide in direction D; and two screws 65, which extend through respective wings 54 of fastening member 50 in a direction parallel to direction C, are screwed inside respective holes 66 through bar 64, and engage, loosely in direction D, respective through slots 67 formed along raised portion 48.

More specifically, bar 64 engages in sliding manner a C-shaped groove formed along raised portion 48 of supporting member 35, on the opposite side to retaining member 60, and extending parallel to direction D.

Wings 54 of fastening member 50 have respective through holes 69 having axes parallel to direction C and engaged by respective screws 65.

Slots 67 are elongated in direction D and formed along raised portion 48, on opposite sides of retaining member 60.

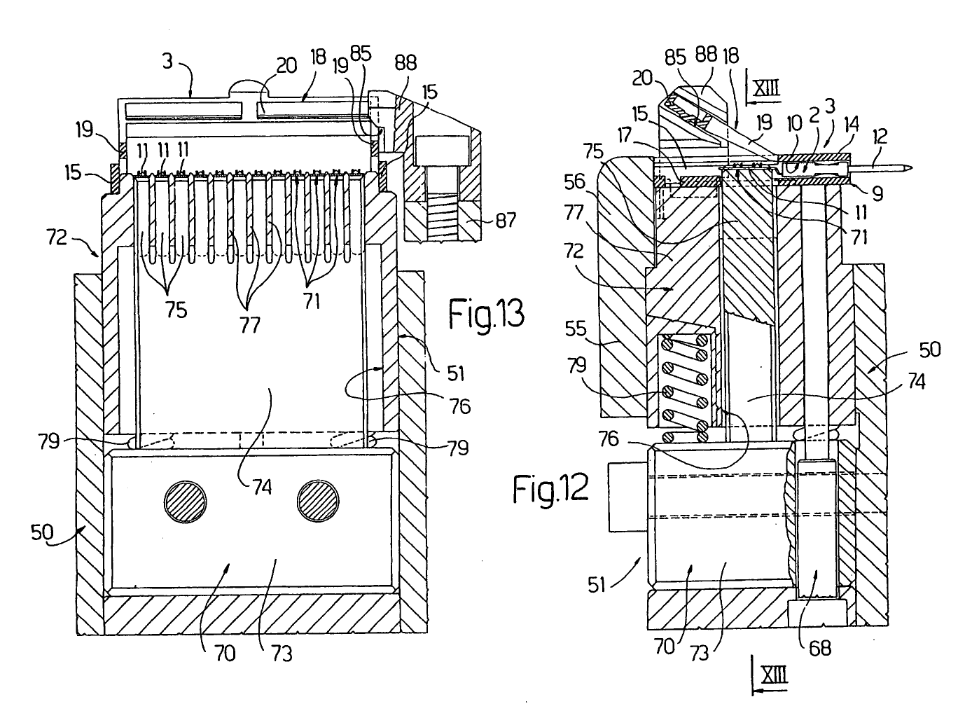

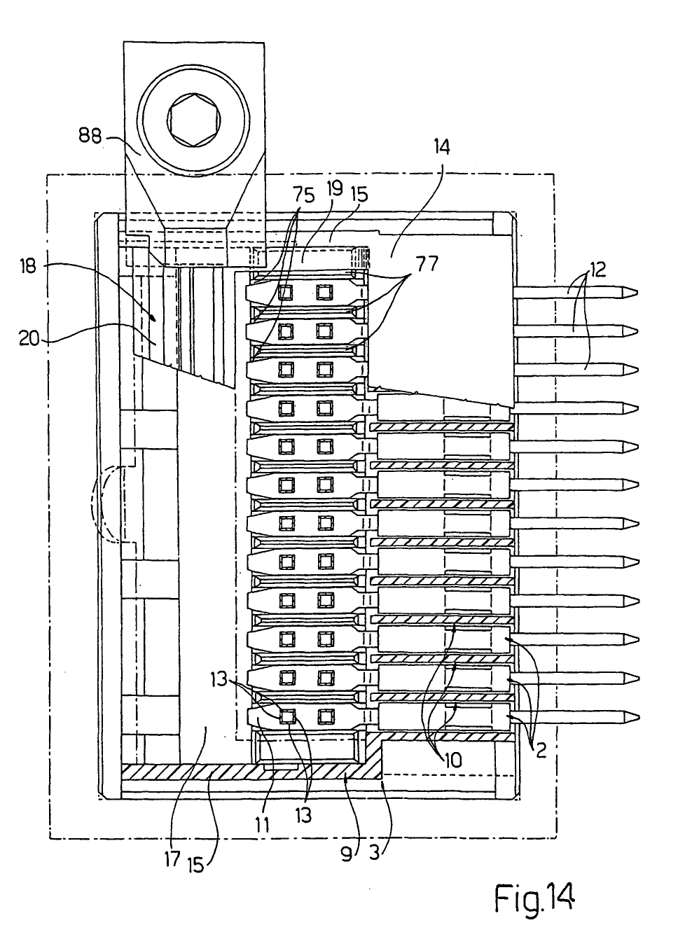

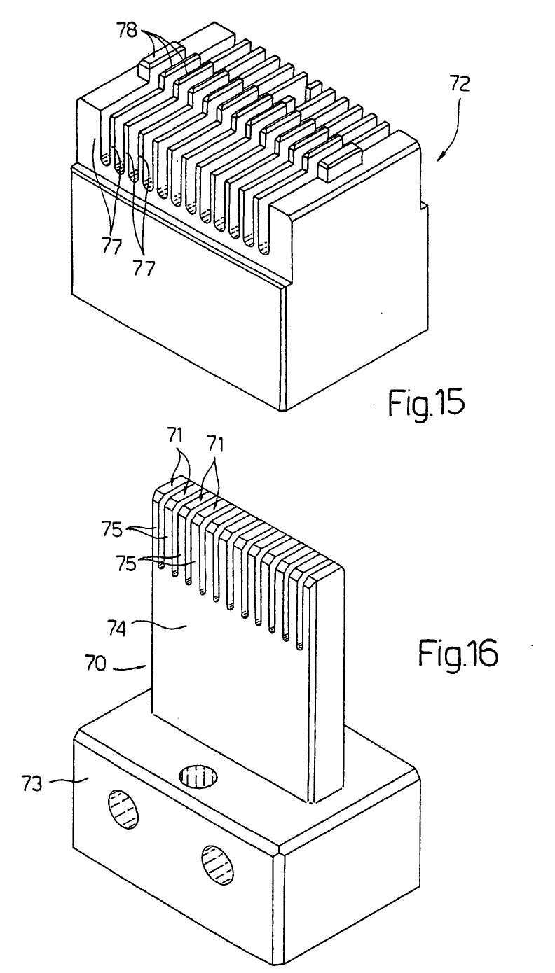

With reference to FIGS. 4, 7, 8, 12, 13 and 14, anvil 51 comprises a counterpressure member 70 for counteracting the thrust exerted by pressure assembly 27 during the crimping operation, and defining a number of supporting surfaces 71 for connecting portions 11 of respective terminals 2 of connector 3; and a locating member 72, which is fitted, movably in direction B, to counterpressure member 70, cooperates with connecting portions 11 of terminals 2 to center the connecting portions, in direction D, on respective supporting surfaces 71, and selectively releases connecting portions 11 when pressure assembly 27 is moved towards anvil assembly 26.

More specifically, counterpressure member 70 comprises a parallelepiped-shaped base portion 73 housed inside seat 52 of fastening member 50 and fixed to end portion 53 of fastening member 50 by two screws; and a substantially parallelepiped-shaped comb portion 74 projecting in direction B from a centerline portion of a top surface of base portion 73, and defining, at a top end, a number of vertical teeth 75 for supporting connecting portions 11 of respective terminals 2 of connector 3.

More specifically, teeth 75, which are equal in number to terminals 2 of connector 3 for crimping, extend parallel to one other in direction B, have a rectangular section, and define, at their free ends, bottom supporting surfaces 71 for supporting connecting portions 11 of respective terminals 2.

Locating member 72 is defined by a substantially parallelepiped-shaped body having an inner cavity 76 for housing comb portion 74 of counterpressure member 70, and defining, at the top, a number of parallel vertical teeth 77, as shown clearly in FIGS. 12 and 13. Teeth 77 are connected to one another at the bottom by connecting portions, along which are formed respective through openings communicating with cavity 76 to permit insertion of teeth 75 of counterpressure member 70 between respective pairs of teeth 77.

More specifically, teeth 77 are arranged side by side in direction D, and have, at the top, respective central appendixes 78 of substantially the same length as teeth 75 in direction C, and tapering towards their free ends so as to gradually interact laterally, when loading connector 3 downwards onto anvil 51, with connecting portions 11 of terminals 2 of connector 3, and so center the terminals on supporting surfaces 71 of respective teeth 75 of counterpressure member 70.

Locating member 72 rests on base portion 73 of counterpressure member 70 by means of two cylindrical coil springs 79 which, in the absence of external stress, keep the locating member raised slightly with respect to base portion 73 in direction B.

The thrust exerted by pressure assembly 27 on anvil 51 compresses springs 79, so that locating member 72 moves down in direction B into contact with base portion 73 of counterpressure member 70, and connecting portions 11 of terminals 2 are released for crimping to crimping portion 8 of flat cable 5.

With particular reference to FIGS. 12-14, connector 3 is mounted on anvil 51 with main portion 14 of casing 9 resting on the free ends of teeth 77 on the side facing end portion 53 of fastening member 50, and with arms 15 resting on the free ends of the end teeth 77 of locating member 72, and resting at the front against portion 56 of cover 55.

More specifically, arms 15 of connector 3 are fitted on opposite sides of appendixes 78 of the end teeth 77 of locating member 72, so that the hinge axis A of cover 18 is parallel to direction D.

Counterpressure and locating members 70 and 72 are available with different numbers of teeth 75 and 77 so as to adapt to connectors 3 with different numbers of terminals 2.

With reference to FIGS. 3, 4, 7 and 8, anvil assembly 26 also comprises a retaining device 80 cooperating with connector 3 to keep cover 18 in a predetermined raised open position forming a predetermined angle with main portion 14 and arms 15 of casing 9.

Device 80 substantially comprises a U-shaped guide member 81 fixed to fastening member 50; and a lock member 82 defined by a slide 83 fitted to guide member 81 so as to slide in direction D, and by a retaining member 84 projecting from the slide in direction C and defining a seat 85 for retaining one of lateral portions 19 of cover 18 of connector 3.

More specifically, guide member 81 extends over raised portion 48 of supporting member 35 and parallel to direction D, and is fixed to and projects from end portion 53 of fastening member 50.

Retaining member 84 is substantially L-shaped, and comprises an anchoring portion 86 connected integrally and releasably to a top face of slide 83; and a retaining arm 87, which projects from anchoring portion 86 in direction C, is located over one of wings 54 of fastening member 50, and has, on its free end, an enlargement 88 comprising seat 85.

More specifically, seat 85 is defined by a groove formed in enlargement 88, and which slopes with respect to directions B, C and D, and is engaged by a relative lateral portion 19 of cover 18 of connector 3 to keep cover 18 in the predetermined raised open position, i.e. at a predetermined angle with respect to casing 9.

At the opposite end to that from which retaining arm 87 projects, slide 83 has an idle roller 89, which rolls along a bottom surface of guide member 81 and cooperates with a cam control member 90 carried by pressure assembly 27 and described in detail later on.

Slide 83 and retaining member 84 are movable along guide member 81 between a first operating position retaining cover 18 of connector 3, and a second operating position releasing cover 18, so that connector 3 can be loaded onto anvil 51, and cover 18 can be clicked onto casing 9.

Slide 83 and retaining member 84 are moved from the first to the second operating position by control member 90 interacting with roller 89 as pressure assembly 27 moves down in direction B, and are moved from the second to the first operating position by a known actuating member—not shown, by not forming part of the present invention—when slide 34 is set to the rear position along rails 33 and after loading connector 3 onto anvil 51.

Retaining member 84 is fixed to slide 83 by a screw 91 engaging a slot 92 formed through anchoring portion 86, and a threaded hole 93 formed on slide 83. Slot 92, which is elongated in direction D, provides for adjusting the position of retaining member 84—and, in particular, of retaining arm 87—to connectors 3 with any number of terminals 2.

Anvil assembly 26 also comprises an ejecting device—not described, by not forming part of the present invention—which is activated selectively at the end of the crimping operation to eject the crimped connector 3 and flat cable 5 from anvil 51.

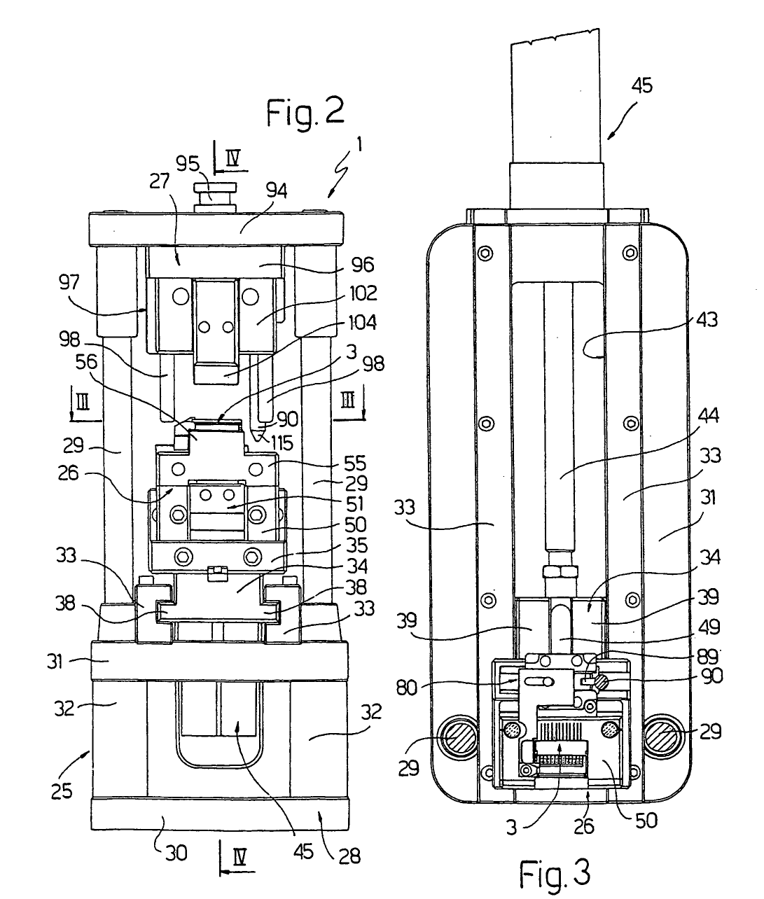

With reference to FIGS. 1, 2i 4, 17 and 18, pressure assembly 27 comprises a horizontal plate 94 mounted to slide axially along columns 29 and having an attachment 95 at the top for known actuating means not shown; a supporting member 96 fixed to the underside of plate 94; and a thrust assembly 97, which is pressed onto anvil 51, is connected to supporting member 96 adjustably in direction D, and has two vertical guide columns 98, which engage respective vertical holes 99 formed in fastening member 50 of anvil assembly 26 to vertically align thrust assembly 97 and receiving assembly 36.

More specifically, viewed laterally, supporting member 96 is inverted-L-shaped, and comprises a base portion 100 in the form of a rectangular plate fixed by screws to a bottom surface of plate 94; and a rear projecting portion 101 projecting perpendicularly from the rear end of base portion 100 and facing raised portion 48 of supporting member 35.

Thrust assembly 97 comprises a substantially parallelepiped-shaped fastening member 102, from which guide columns 98 project integrally; fastening means 103 for fastening fastening member 102 to projecting portion 101 of supporting member 96 in an adjustable position in direction D; and two pressure matrixes 104, 105 carried by fastening member 102 and cooperating respectively with cover 18 of connector 3, to press the cover shut on casing 9, and with crimping portion 8 of flat cable 5, to crimp crimping portion 8 to connecting portions 11 of terminals 2.

More specifically, fastening means 103 comprise a bar 106 fitted to projecting portion 101 of supporting member 96, on the opposite side to fastening member 102, so as to slide in direction D; and two screws 107, which extend through the body of fastening member 102 in a direction parallel to direction C, are screwed inside respective holes 108 through bar 106, and engage, loosely in direction D, respective through slots 109 formed along projecting portion 101.

More specifically, bar 106 engages in sliding manner a C-shaped groove formed along projecting portion 101 of supporting member 96, on the opposite side to fastening member 102, and extending parallel to direction D.

Matrix 105 is fixed by screws to fastening member 102, is positioned facing teeth 75 of counterpressure member 70, and projects downwards with respect to fastening member 102.

On its bottom pressure surface, matrix 105 has two adjacent rows of projections ill, each substantially truncated-pyramid-shaped with a square base and tapering in section towards the free end.

Each projection 111 is aligned in direction C with a corresponding projection 111 in the other row, and in direction D with the other projections 111 in the same row.

When matrix 105 is pressed onto supporting surfaces 71 of anvil 51, each projection 111 presses crimping portion 8 of flat cable 5 onto a connecting portion 11 of a relative terminal 2, so that relative spikes 13 locally pierce crimping portion 8. Being truncated-pyramid-shaped, each projection 111 is inserted inside a relative group of spikes 13, and presses the spikes gradually onto a relative conducting track 4 on crimping portion 8 of flat cable 5, and outwards of the square area defined by spikes 13.

Matrix 104 is fitted in sliding and nonwithdrawable manner inside a vertical through seat 112 in fastening member 102, and is loaded-towards anvil assembly 26 by a spring 113. More specifically, matrix 104 is maintained by spring 113 in a forward position closer to anvil assembly 26 with respect to matrix 105, so that, when pressure assembly 27 moves down in direction B, matrix 104 first contacts cover 18 of connector 3, and, only when spring 113 is compressed, can matrix 105 be inserted through the opening in cover 18 to act on crimping portion 8 of flat cable 5 and on connecting portions 11 of terminals 2.

Cam control member 90 projects integrally from fastening member 102, and is defined, in the example shown, by a cylindrical pin projecting from the bottom of fastening member 102 and having a conical free end 115 which interacts with roller 89.

Unit 1 operates as follows:

Before commencing a crimping cycle of a series of flat cables 5, receiving assembly 36 of anvil assembly 26 and thrust assembly 97 of pressure assembly 27 are positioned, in direction D, so that conducting tracks 4 on crimping portions 8 of flat cables 5 fed to unit 1 are aligned with terminals 2 of connectors 3 to be crimped to cables 5.

This is done taking into account the position in which crimping portions 8 of flat cables 5 are fed to unit 1, and the number of conducting tracks 4 on each crimping portion 8, which obviously equals the number of terminals 2 on each connector 3.

More specifically, on the basis of the above parameters, seat 52 on fastening member 50 is fitted with a counterpressure member 70 having a number of teeth 75 equal to the number of terminals 2 for crimping, and with a locating member 72 having a number of teeth 77 increased by one with respect to the number of teeth 75.

After loosening screws 65, fastening member 50 is moved in direction D, with respect to supporting member 35 and retaining member 60, into the desired position, and is then fastened in direction C to raised portion 48 of supporting member 35 by inserting projections 61 on retaining member 60 inside respective grooves 57 on fastening member 50. At which point, screws 65 are tightened down again.

The same adjustment is also made to thrust assembly 97 of pressure assembly 27. More specifically, after loosening screws 107 to move fastening member 102 in direction D with respect to supporting member 96, pressure assembly 27 is moved in direction B towards anvil assembly 26 to position the free ends of guide columns 98 close to receiving assembly 36.

Fastening member 102 is then moved in direction D to enable guide columns 98 to engage respective holes 99 in fastening member 50.

At this point, screws 107 are tightened, and pressure assembly 27 restored to the raised start position.

The setup procedure is completed by positioning retaining member 84 of lock member 82, in direction D and with respect to slide 83, so that seat 85 is engaged by the relative lateral portion 19 of cover 18 of each connector 3 to be crimped to respective flat cable 5.

Terminals 2 of connector 3 are crimped to crimping portion 8 of a relative flat cable 5 as follows:

First of all, actuating member 45 is operated to move slide 34, together with anvil assembly 26, along rails 33 into the rear loading position to load a connector 3 into a fixed position on the anvil.

At this stage, lock member 82 is set to the second operating position to avoid interfering with the loading of connector 3.

Connector 3 is loaded onto anvil 51 with arms 15 on the outside of appendixes 78 of end teeth 77 of locating member 72, and resting at the front against portion 56 of cover 55.

More specifically, connecting portion 11 of each terminal 2 is loaded downwards onto the free end of a relative tooth 75 of counterpressure member 70; in the course of which, connecting portion 11 of each terminal 2 is inserted between appendixes 78 of a relative pair of teeth 77 on locating member 72, which define the position of the connecting portion on relative tooth 75 of counterpressure member 70.

Lock member 82 is then moved into the first operating position, in which a relative lateral portion 19 of cover 18 engages seat 85.

At this point, slide 34 can be moved back into the front operating position to perform the actual crimping operation.

Crimping portion 8 of flat cable S is inserted between arms 15 of casing 9 of connector 3, and is interposed between connecting portions 11 of terminals 2 and cover 18.

As pressure assembly 27 is lowered, guide columns 98 first engage holes 99 in fastening member 50 of anvil assembly 26, and the conical end 115 of cam control member 90 then interacts with roller 89 of lock member 82.

The thrust exerted by control member 90 moves lock member 82 into the second operating position to temporarily release cover 18 of connector 3.

Over the next portion of the downward travel of pressure assembly 27, matrix 104 contacts and presses cover 18 onto flat cable 5 so that cover 18 clicks onto arms 15 of casing 9.

At this point, as pressure assembly 27 continues moving down, spring 113 is compressed, so that pressure assembly 27 moves in direction B with respect to matrix 104 to bring matrix 105 into contact with crimping portion 8 of flat cable 5.

At the same time, the thrust exerted by pressure assembly 27 on anvil 51 compresses springs 79, so that locating member 72 moves down to release connecting portions 11 of terminals 2.

As matrix 105 is pressed onto supporting surfaces 71 of counterpressure member 70, projections 111 of matrix 105 press crimping portion 8 of flat cable 5 onto connecting portions 11 of terminals 2, so that crimping portion 8 is pierced locally by spikes 13. More specifically, being truncated-pyramid-shaped, each projection 111 of matrix 105 is inserted inside a relative group of spikes 13, and presses the spikes gradually onto a relative conducting track 4 on crimping portion 8 of flat cable 5, and outwards of the square area defined by spikes 13.

At the end of the crimping operation, pressure assembly 27 is restored to the raised start position, and ejecting device 68 is activated to detach the crimped connector 3 and flat cable 5 from anvil 51.

The advantages of unit 1 according to the present invention will be clear from the foregoing description.

In particular, by being able to adjust, in direction D, the position of receiving assembly 36 and thrust assembly 97 with respect to relative supporting members 35 and 96, unit 1 can be adapted to crimp connectors 3 with any number of terminals 2 to crimping portions 8 of flat cables 5 having a corresponding number of conducting tracks and fed in different positions to unit 1.

Moreover, this is achievable with no adaptation required to the devices for feeding flat cables 5 and connectors 3 to unit 1, which may therefore be fed through the loading areas of unit 1 in a fixed position.

Finally, loading connectors 3 onto anvil assembly 26 positioned outside the work area of pressure assembly 27 allows greater freedom in the design of the device for loading connectors 3 onto unit 1.

Clearly, changes may be made to unit 1 without, however, departing from the scope of the present invention.

1) A unit (1) for crimping electric terminals (2) to respective conducting tracks (4) of a flat cable (5); said terminals (2) being carried by an insulating casing (9) of an electric connector (3); and said flat cable (5) comprising at least one strip (6) of insulating material, and a number of said conducting tracks (4) applied longitudinally and parallel to one another along said strip (6); said unit (1) comprising:
an anvil assembly (26) having receiving means (36) for receiving said connector (3); and
a pressure assembly (27) movable to and from said anvil assembly (26) in an approach direction (B) and comprising matrix means (104, 105) which are pressed onto said receiving means (36) to crimp said terminals (2) of said connector (3) to respective said conducting tracks (4) of a crimping portion (8) of said flat cable (5);
characterized by comprising adjustable fastening means (37) for fixing said receiving means (36) and said matrix means (104, 105) to first and second supporting means (35; 96) respectively in a number of lock positions in an adjustment direction (D) crosswise to said flat cable (5) and to said approach direction (B), so as to align said conducting tracks (4) of said flat cable (5) with said terminals (2) of said connector (3) regardless of the number of conducting tracks (4) and terminals (2), and regardless of the position in which said crimping portion (8) of said flat cable (5) is fed to said unit (1).

2) A unit as claimed in claim 1, characterized in that said adjustable fastening means (37) comprise a number of first retaining members (57) carried by one of said receiving means (36) and said first supporting means (35) and arranged in succession in said adjustment direction (D); and at least one second retaining member (61) carried by the other of said receiving means (36) and said first supporting means (35) and connectable selectively to one of said first retaining members (57) to define a corresponding said lock position of said receiving means (36) to said first supporting means (35).

3) A unit as claimed in claim 2, characterized in that said adjustable fastening means (37) comprise aligning means (98, 99) for aligning said matrix means (104, 105) and said receiving means (36).

4) A unit as claimed in claim 3, characterized in that said adjustable fastening means (37) comprise releasable first and second locking means (63, 103) for fixing said receiving means (36) and said matrix means (104, 105) in the required lock position to said first and second supporting means (35, 96) respectively.

5) A unit as claimed in any one of claims 2 to 4, characterized in that said first retaining members comprise a number of grooves (57) associated with said receiving means (36) and extending parallel to said approach direction (B); and in that said second retaining member comprises a projection (61) integral with said first supporting means (35) and complementary in shape to said grooves (57).

6) A unit as claimed in claim 5, characterized in that said receiving means (36) comprise a fastening member (50) having said grooves (57) and defining a seat (52) for an anvil (51) defining a number of supporting surfaces (71) for respective said terminals (2) of a said connector (3).

7) A unit as claimed in any one of claims 3 to 6, characterized in that said aligning means comprise at least one guide column (98) integral with said matrix means (104, 105) and which fits inside a respective seat (99) associated with said receiving means (36).

8) A unit as claimed in any one of the foregoing Claims, characterized in that said anvil assembly (26) is movable, in a direction (C) crosswise to said approach direction (B), between a loading position outside the work area of said pressure assembly (27) to allow a said connector (3) to be loaded onto said receiving means (36), and a work position holding a relative said connector (3) in position facing said pressure assembly (27) to allow the terminals (2) of the connector (3) to be crimped to a relative said flat cable (5).
